(19) United States
(12) Patent Application Publication
(10) Pub. No.: US 2016/0139422 A1
(43) Pub. Date: May 19, 2016

(54) THREE-DIMENSIONAL IMAGE DISPLAY APPARATUS

(71) Applicant: InnoLux Corporation, Miao-Li County (TW)

(72) Inventor: Naoki SUMI, Miao-Li County (TW)

(21) Appl. No.: 14/540,354

(22) Filed: Nov. 13, 2014

(51) Int. Cl. G02B 27/22; G02F 1/137

(52) U.S. Cl. CPC G02B 27/2214; G02F 1/137

(57) ABSTRACT

A three-dimensional (3D) image display apparatus comprises a tracking module, a backlight module, a first optical structure, a display panel and a second optical structure. The tracking module outputs a coordinate information of a target. The backlight module outputs a light. The first optical structure is disposed on the backlight module and splits the light into at least two light beams. The display panel is disposed on the first optical structure and converts the light beams into a plurality of images according to the coordinate information. The second optical structure is disposed on the display panel and changes the emission angles of the images of the display panel to achieve the multi-view effect.

### BACKGROUND OF THE INVENTION

1. Field of Invention

The invention relates to a three-dimensional (3D) image display apparatus and, in particular, to a three-dimensional (3D) image display apparatus having a tracking module.

2. Related Art

Generally, a 3D image display apparatus can be divided into a glasses-wearing type and a glasses-free type. For the glasses-wearing 3D image display technology, the user needs to wear specially-designed glasses, such as shutter glasses, so that the user's left and right eyes can receive different images to perceive the stereoscopic images thereby. For the glasses-free 3D image display apparatus, a special optical element, such as a parallax barrier, is disposed in the display apparatus, so that the display apparatus can provide different images to the left and right eyes of the user, and therefore the user can perceive the stereoscopic images without wearing auxiliary glasses.

However, some limitation exists in the glasses-free 3D image display apparatus for the viewing. For example, the user can only view the complete stereoscopic image from a few of particular viewing angles and will just perceive 2D images or broken stereoscopic images from other viewing angles, and therefore the viewing angle of the user is limited and the viewing quality is reduced.

To achieve the above problem, some companies have developed a multi-view 3D image display apparatus, in which a special optical modulating element that can provide the light in multiple angles to form the stereoscopic image, and therefore the user can view the 3D stereoscopic image from different viewing angles without being limited in specially appointed viewing angles. However, the user can perceive the stereoscopic image when receiving just two light beams by the eyes, and the image light beams emitted in different angles by the 3D image display apparatus at the same time will not “all” go into the eyes of the same user, so the ineffective energy consumption is caused and the display efficiency of the 3D image display apparatus is thus reduced.

Moreover, the conventional 3D image display apparatus has the problem named “accommodation-convergence conflict” that is caused by the lack of eye accommodation induced stereoscopic recognition (i.e. monocular 3D vision). Recently, the super multi-view image display apparatus that has an included angle between 0.2° and 0.4° for the adjacent light beams are proposed to solve this problem. However, it requires more views like 72 to 128 views and reduces display resolution of the 3D image display apparatus more.

Therefore, it is an important subject to provide a 3D image display apparatus which can provides stereoscopic images with multiple viewing angles without ineffective energy consumption so that the display efficiency can be enhanced.

### SUMMARY OF THE INVENTION

In view of the foregoing subject, an objective of the invention is to provide a 3D image display apparatus which can provide stereoscopic images with multiple viewing angles for binocular 3D vision and also accommodation to human eye with high density multiple views for monocular 3D vision at the same time to solve the accommodation-convergence conflict problem without ineffective energy consumption so that the display efficiency can be enhanced.

To achieve the above objective, a three-dimensional (3D) image display apparatus according to this invention comprises a tracking module, a backlight module, a first optical structure, a display panel and a second optical structure. The tracking module outputs a coordinate information of a target. The backlight module outputs a light. The first optical structure is disposed on the backlight module and splits the light into at least two light beams. The display panel is disposed on the first optical structure and converts the light beams into a plurality of images according to the coordinate information. The second optical structure is disposed on the display panel and changes the emission angles of the images of the display panel to achieve the multi-view effect.

In one embodiment, the first optical structure includes a plurality of first optical units, each of the first optical units includes a first light pervious region and a first light impervious region, and the first light pervious region and the first light impervious region are disposed adjacent to each other.

In one embodiment, the second optical structure includes a plurality of second optical units, and the projection area of each of the first optical units on the second optical structure covers two of the second optical units.

In one embodiment, the first optical structure comprises a first substrate, a second substrate, a liquid crystal layer, a plurality of first electrodes and a plurality of second electrodes. The second substrate is disposed opposite the first substrate. The liquid crystal layer is disposed between the first substrate and the second substrate. The first electrodes are disposed on the first substrate and separated from each other. The second electrodes are disposed on the second substrate. The liquid crystal layer forms the first light pervious region and the first light impervious region according to a plurality of driving voltages applied to the first electrodes.

In one embodiment, the values of the driving voltages are adjusted according to the coordinate information.

In one embodiment, the first optical structure is a barrier.

In one embodiment, the second optical structure is a lenticular lens and includes a plurality of lens units, and each of the second optical units includes one of the lens unit.

In one embodiment, the second optical structure comprises a first substrate, a second substrate, a liquid crystal layer, a plurality of first electrodes and a plurality of second electrodes. The second substrate is disposed opposite the first substrate. The liquid crystal layer is disposed between the first substrate and the second substrate. The first electrodes are disposed on the first substrate and separated from each other. The second electrodes are disposed on the second substrate. The liquid crystal layer forms a plurality of lens units according to a plurality of driving voltages applied to the first electrodes, and each of the second optical units includes a lens unit.

In one embodiment, the second optical structure comprises a first substrate, a second substrate, a liquid crystal layer, a plurality of first electrodes and a plurality of second electrodes. The second substrate is disposed opposite the first substrate. The liquid crystal layer is disposed between the first substrate and the second substrate. The first electrodes are disposed on the first substrate and separated from each other. The second electrodes are disposed on the second substrate. The liquid crystal layer forms the second light pervious region and the second light impervious region according to a plurality of driving voltages applied to the first electrodes. Each of the second optical units includes the second light pervious region and the second light impervious region, and the second light pervious region and the second light impervious region are disposed adjacent to each other.

In one embodiment, the second optical structure is a barrier and includes the second optical units, each of the second optical units includes a light pervious region and a light impervious region, and the light pervious region and the light impervious region are disposed adjacent to each other.

In one embodiment, along the direction perpendicular to the display panel, the distance from a thickness middle of the second optical structure to a thickness middle of the display panel is at least twice the distance from a thickness middle of the display panel to a thickness middle of the first optical structure.

In one embodiment, the adjacent images have an included angle between 0.2° and 0.4°.

### BRIEF DESCRIPTION OF THE DRAWINGS

The invention will become more fully understood from the detailed description and accompanying drawings, which are given for illustration only, and thus are not limitative of the present invention, and wherein:

FIG. 1A is a schematic block diagram of a 3D image display apparatus of an embodiment of the invention;

FIG. 1B is a schematic diagrams of the pixels of the display panel in FIG. 1A;

FIG. 2A is a schematic diagram of a 3D image display apparatus of the first embodiment of the invention;

FIG. 2B is a schematic diagram of another 3D image display apparatus of the first embodiment of the invention;

FIG. 3 is a schematic diagram of a 3D image display apparatus of the second embodiment of the invention;

FIG. 4 is a schematic diagram of a 3D image display apparatus of the third embodiment of the invention;

FIG. 5 is a schematic diagram of a 3D image display apparatus of the fourth embodiment of the invention; and

FIG. 6 is a schematic diagram of a 3D image display apparatus of the fifth embodiment of the invention.

### DETAILED DESCRIPTION OF THE INVENTION

The present invention will be apparent from the following detailed description, which proceeds with reference to the accompanying drawings, wherein the same references relate to the same elements.

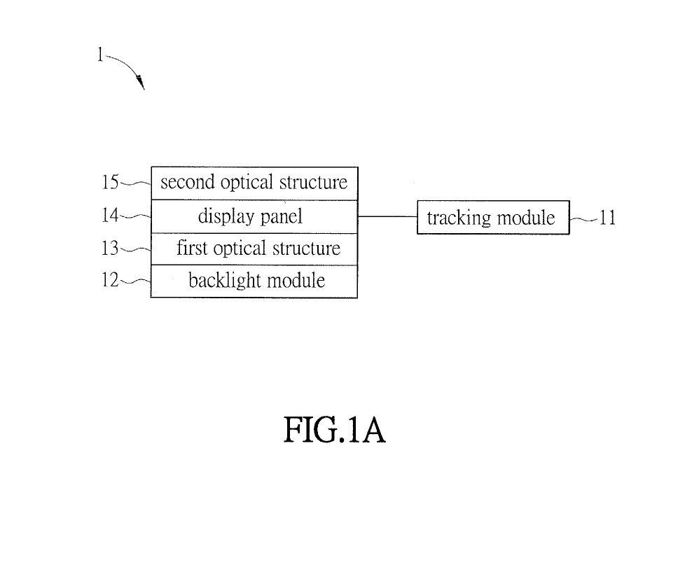

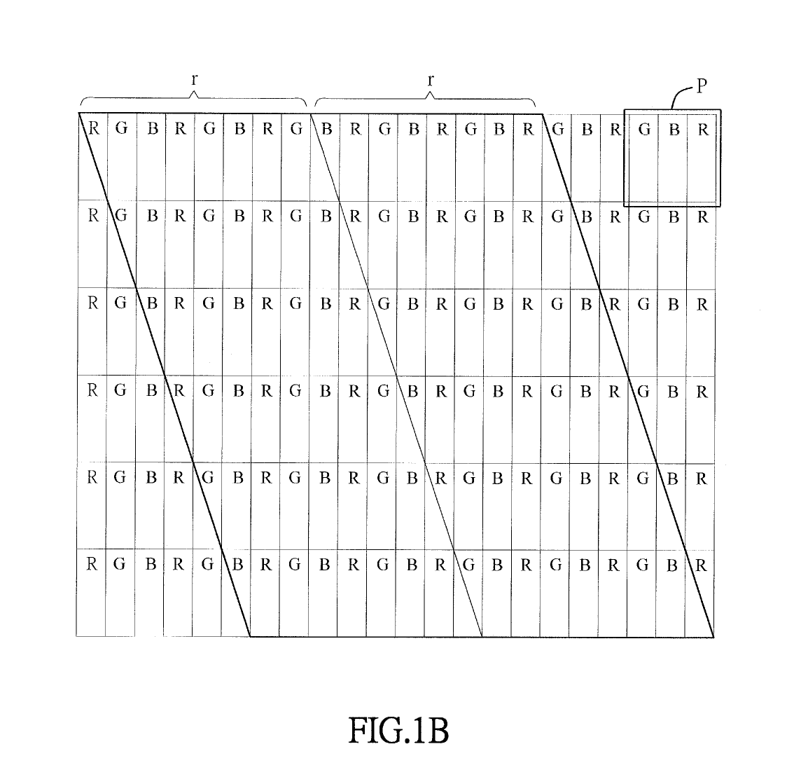

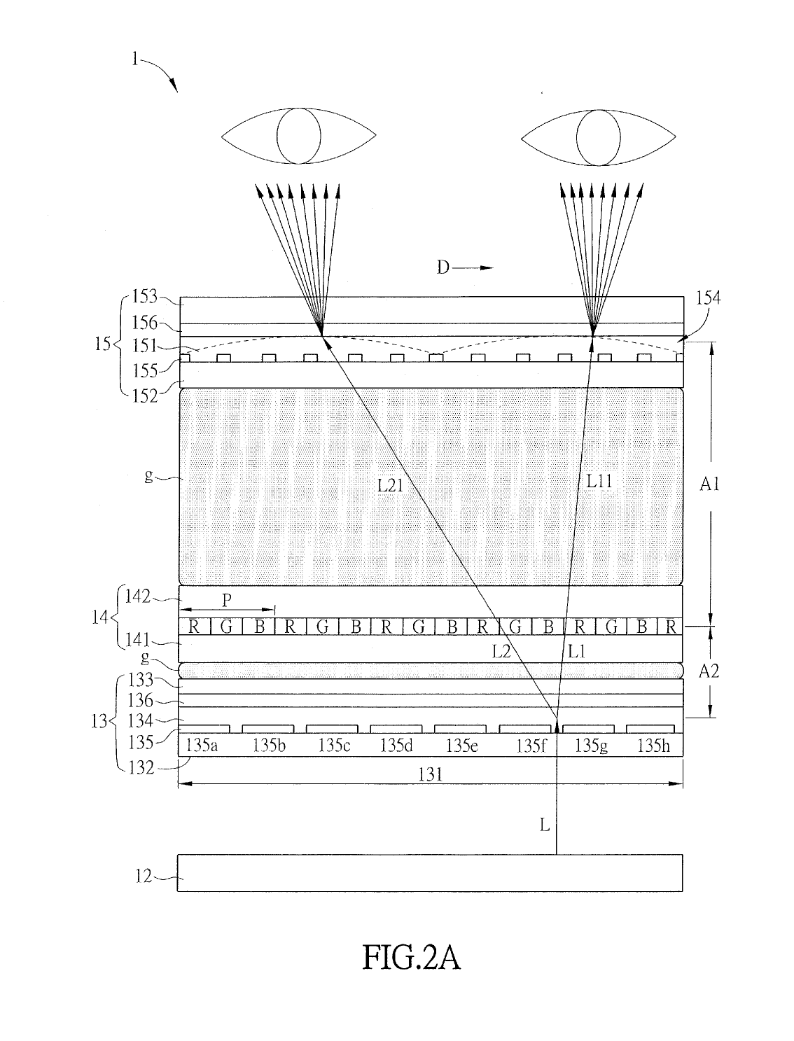

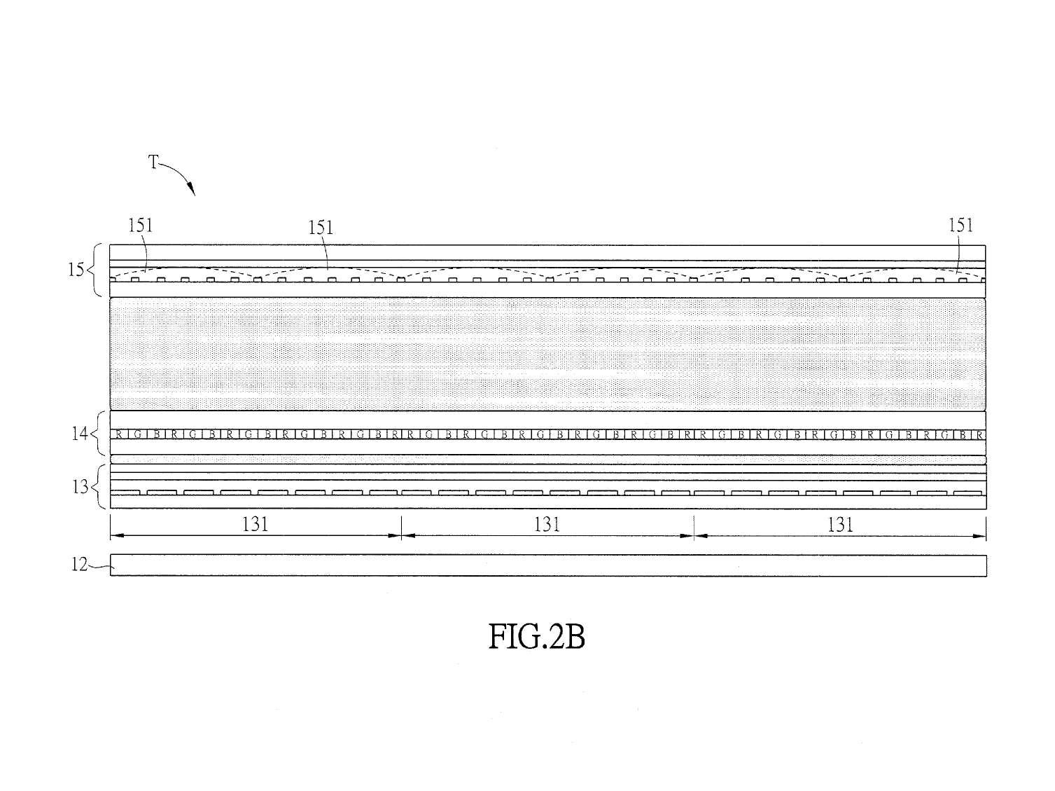

FIG. 1A is a schematic block diagram of a 3D image display apparatus of an embodiment of the invention, FIG. 1B is a schematic diagrams of the pixels of the display panel in FIG. 1A, FIG. 2A is a schematic diagram of a 3D image display apparatus of the first embodiment of the invention. As shown in FIGS. 1A, 1B, 2A, the 3D image display apparatus 1 includes a tracking module 11, a backlight module 12, a first optical structure 13, a display panel 14 and a second optical structure 15.

The tracking module 11 can output a coordinate information of a target. In this embodiment, the tracking module 11 is used to track the target, which is, for example, the middle of the user's face, middle of each eye of the user, middle of the user's eyes or middle of the user's forehead. The tracking module 11 continuously tracks the target to output a coordinate information of the target instantly or at least once for every frame time. The coordinate information represents the 3D coordinate information of the target's location.

The backlight module 12 acts as the light source of the 3D image display apparatus 1 and can output a light. In practice, the backlight module 12 can be a direct-type light source or an edge-type light source for example.

The first optical structure 13 is disposed on the backlight module 12 and can split the light into at least two light beams that are transmitted to the left eye and right eye of the user to show the stereoscopic image. In this embodiment, the first optical structure 13 includes a plurality of first optical units 131 which are disposed between the display panel 14 and the backlight module 12 along the arrangement direction D. Each of the first optical units 131 includes a first light pervious region and a first light impervious region, and the first light pervious region and the first light impervious region are disposed adjacent to each other.

Furthermore, the first optical structure 13 of this embodiment is a switchable barrier and includes a first substrate 132, a second substrate 133, a liquid crystal layer 134, a plurality of first electrodes 135 and a plurality of second electrodes 136. The second substrate 133 is disposed opposite the first substrate 132. The liquid crystal layer 134 is disposed between the first substrate 132 and the second substrate 133. The first electrodes 135 are separated from each other and disposed on the first substrate 132. The second electrodes 136 are disposed on the second substrate 133. The liquid crystal layer 134 forms the first optical units 131 according to a plurality of driving voltages applied to the first electrodes 135. For example, the first optical unit 131 can be defined to cover the eight consecutive first electrodes 135, and the four consecutive first electrodes 135 are supplied with 5V voltage (high level) and the remaining four first electrodes 135 are not supplied with voltage (low level), while the second electrodes 136 are not supplied with voltage (low level). Meanwhile, the liquid crystal cells of the liquid crystal layer 134 will completely rotate or not rotate according to the applied voltage. Therefore, the liquid crystal layer 134 can show the first light pervious regions which are pervious to light and the first light impervious regions which are impervious to the light, and thus forms the first optical units 131 like the parallax barrier. In this embodiment, each of the first light pervious regions or first light impervious regions covers the width of four first electrodes 135. In other embodiment, each of the light pervious regions or light impervious regions can cover the width of the first electrodes 135 of another quantity. Hence, the light of the backlight module 12 can pass through the first light pervious regions of the first optical units 131 and then split into the light beam for entering the left eye and the light beam for entering the right eye, so that the 3D image display apparatus can display stereoscopic images. To be noted, since each of the first optical units 131 covers the eight first electrodes 135 and the first optical units 131 are also disposed adjacent to each other, the first light pervious region and/or the first light impervious region can be formed to cover a single first optical unit 131 or the adjacent two first optical units 131. Moreover, the 5V applied voltage is just for the illustrative purpose and can be changed according to the product design. Besides, the high and low level arrangement of the first electrode 135 and the second electrode 136 also can be changed according to the requirement.

In another embodiment, the applied voltage of the first electrodes 135 of the first optical structure 13 can be switched to high or low according to a first switching frequency. The first switching frequency can correspond to a first time segment and a second time segment which are arranged alternately. The first switching frequency can be 140 Hz for example. Physically, the first electrode 135 at the high level during the first time segment will be switched to the low level during the second time segment. Likewise, the first electrode 135 at the low level during the first time segment will be switched to the high level during the second time segment. In other words, by the first switching frequency changing the applied voltage of the first electrode 135, the first light pervious regions and the first light impervious regions formed by the first optical units 131 can be rapidly switched and the position of the first light pervious regions can be thus rapidly switched.

The display panel 14 is disposed on the first optical structure 13 and can be a liquid crystal display (LCD) panel, a MEMS (microelectromechanical system) display panel or other display panels pervious to the light. Herein for example, the display panel 14 is an LCD panel.

The display panel 14 can convert the light beams into a plurality of images according to the coordinate information. Physically, the display panel 14 includes a plurality of pixels P arranged in an array, and each of the pixels P includes three sub-pixels R, G, B. The pixels P provide the left-eye images and the right-eye images according to the coordinate information, and the light entering the display panel 14 will be converted into the images by the pixels P. Favorably, the same pixel P can alternately provide the left-eye images and the right-eye images in different time segments according to a second switching frequency (e.g. 120 Hz). The second switching frequency of the pixels P of the display panel 14 can be the same as the first switching frequency of the first electrodes 135 of the first optical structure 13. In other embodiments, each of the pixels P may have two, or four, or more sub-pixels. Moreover, the first optical units 131 are disposed in a slant manner in relation to the display panel 14.

In an embodiment, the 3D image display panel 1 can further include a processing module (not shown), which is connected to the tracking module 11 and the display panel 14. The processing module can receive the coordinate information of the tracking module 11 and control the pixels P to display images. In this embodiment, the processing module is further connected to the first optical structure 13 to control the first optical structure 13 according to the coordinate information (which will be described later). Otherwise, the processing module may be integrated with the tracking module 11, the display panel 14 or other elements.

In this embodiment, that the first electrodes 135 of the first optical structure 13 are supplied with voltage or not can be controlled by the coordinate information provided by the tracking module 11. That is, the values of the driving voltages of the first electrodes 135 can be adjusted according to the coordinate information. Physically, as shown in FIGS. 1A and 2A, by taking a first optical unit 131 as an example, when the user is at a first location, the tracking module 11 accordingly provides a first coordinate information to the above-mentioned processing module, and the processing module will apply the voltage (high level) to the first electrodes 135a, 135b, 135c, 135d of the first optical unit 131 according to the first coordinate information while the first electrodes 135e, 135f, 135g, 135h are not supplied with the voltage (low level). Therefore, the four first electrodes 135 supplied with the high level will make the liquid crystal cells rotate to form the first light impervious region that is impervious to the light, while the liquid crystal cells corresponding to the four low-level first electrodes 135 can form the first light pervious region that is pervious to the light. Then, when the user is at a second location, for example, by a lateral move, the tracking module 11 accordingly provides a second coordinate information to the processing module, and the processing module will apply the voltage (high level) to the first electrodes 135b, 135c, 135d, 135e of the first optical unit 131 according to the second coordinate information while the first electrodes 135a, 135f, 135g, 135h are not supplied with the voltage (low level). Therefore, the four first electrodes 135 supplied with the high level can form the first light impervious region while the four low-level first electrodes 135 can form the first light pervious region (which can be formed by the two adjacent first optical units 131). In other words, the processing module can adjust the value of the driving voltage of the first electrodes 135 according to the tracking module 11 tracking the location of the target, and therefore the positions of the first light pervious regions and the first light impervious regions of the first optical structure 13 can be changed transversely to adjust the emitting position of the light so that the light beams can be emitted to the left eye and right eye of the user.

In this embodiment, the display panel 14 includes two opposite substrates 141, 142, and the pixels P are disposed between the substrates 141 and 142. The display panel 14 can further include at least a polarizer (not shown), which can be disposed on a surface of the substrate 141 and/or a surface of the substrate 142. Furthermore, the display panel 14 can include a color filter (not shown) so as to show colorful 2D images. The material and disposition of the above-mentioned polarizer and/or color filter can be comprehended by those skilled in the art and therefore the related descriptions are omitted here for conciseness.

The second optical structure 15 is disposed on the display panel 14. The second optical structure 15 can change the emission angles of the images of the display panel 14 to achieve multi-view effect. That is, the user can see the monocular stereoscopic image from different viewing angles. The second optical structure 15 includes a plurality of second optical units 151, the projection area of each of the first optical units 131 on the second optical structure 15 covers two of the second optical units 151. In this embodiment, each of the second optical units 151 includes a lens unit, and the lens units are disposed on the display panel 14 along the arrangement direction D. Each of the lens units has a curvature radius and the lens units can have the same or different curvature radius, and the same curvature radius is given as an example here. Each of the second optical units 151 is disposed corresponding to a region r of the pixels P and are disposed along the arrangement direction D. As an embodiment, the region which the vertical projection of the second optical units 151 covers is defined as the region r. In this embodiment, the width of each of the regions r covers the width of the eight sub-pixels, and the regions r have the same area. To be noted, the second optical units 151 are disposed in a slant manner in relation to the display panel 14.

The first optical structure 15 of this embodiment is a liquid crystal lens. The first optical structure 15 includes a first substrate 152, a second substrate 153, a liquid crystal layer 154, a plurality of first electrodes 155 and a plurality of second electrodes 156. The second substrate 153 is disposed opposite the first substrate 152, and the liquid crystal layer 154 is disposed between the first substrate 152 and the second substrate 153. The first electrodes 155 are separated from each other and disposed on the first substrate 152. The second electrodes 156 are disposed on the second substrate 153. The liquid crystal layer 154 forms the lens units according to a plurality of driving voltages applied to the first electrodes 155. For example, the six consecutively arranged first electrodes 155 are defined as a unit and supplied with the voltages of 5V, 2V, 0.5V, 0V, 0.5V and 2V, respectively, while the second electrodes 156 are not supplied with the voltage (i.e. 0V), and the liquid crystal cells of the liquid crystal layer 154 will rotate for different angles due to the different applied voltages so as to form the lens-like lens units 151. Thereby, the images of the display panel 14 can be changed in emission angle when passing through the second optical units 151, so that the 3D image display apparatus 1 can possess the multi-view effect. Herein, since each of the second optical units 151 of this embodiment is disposed corresponding to eight sub-pixels, each of the lens units 151 can provide eight views. In other words, the number of the light beams passing through each of the second optical units 151 is equal to that of the sub-pixels covered by each of the second optical units 151. Moreover, when the images pass through the second optical units 151, the adjacent images have the included angle between 0.2° and 0.4°. Besides, since many methods can be used to apply voltages to rotate the liquid crystal cells, the above-mentioned method of applying voltages is just for the illustrative purpose but not for limiting the scope of the invention. In other embodiment, the first optical structure 13 may be a lenticular lens, barrier, or switchable barrier.

In the direction perpendicular to the display panel 14, the distance A1 from the thickness middle of the second optical structure 15 to the thickness middle of the display panel 14 is at least two times the distance A2 from the thickness middle of the display panel 14 to the thickness middle of the first optical structure 13, and is favorably 2˜8 times the distance A2 for providing a proper light path direction for monocular and binocular stereoscopy.

To be noted, in this embodiment, the thickness of the second optical structure 15 is defined as the distance from the outer surface of the second substrate 153 (the surface away from the display panel 14) to the outer surface of the first substrate 152 (the surface facing the display panel 14). The thickness of the display panel 14 is defined as the distance from the outer surface of the substrate 141 (the surface facing the second optical structure 15) to the outer surface of the substrate 142 (the surface facing the first optical structure 13). The thickness of the first optical structure 13 is defined as the distance from the outer surface of the second substrate 133 (the surface facing the display panel 14) to the outer surface of the first substrate 132 (the surface away from the display panel 14). In an embodiment, the second optical structure 15 and the display panel 14 can be separated from each other or attached to each other by an optical adhesive g, and the display panel 14 and the first optical structure 13 also can be separated from each other or attached to each other by an optical adhesive g, as long as the distances A1 and A2 conform to the above-mentioned rule.

As shown in FIGS. 1A, 1B and 2A, the following illustration is given from a whole viewpoint. When the user views the images of the 3D image display apparatus 1 of this embodiment, the tracking module 11 will generate the coordinate information according to the user's location, and the coordinate information will be changed when the user takes a lateral move (leftward and rightward move) in relation to the 3D image display apparatus 1. The light L emitted by the backlight module 12 is divided into the left-eye light beam L1 and the right-eye light beam L2 through the first optical structure 13. The first light pervious regions and the first light impervious regions of the first optical units 131 can be switched according to the change of the coordination information. Then, the light beams L1, L2 will pass through the pixels P to form the images, and the pixels P provide the corresponding left-eye images L11 and the right-eye images L21 according to the coordinate information. Finally, the images L11, L21 will be outputted in many angles through the second optical structure 15 for providing the multi-view effect (herein each of the second optical structures 15 emits 8 light beams for example and the angle between the light beams is just for the illustrative purpose), and therefore the user can view the stereoscopic images without being limited to a fixed position. Herein, the relations of the thickness middles of the display panel 14, first optical structure 13 and second optical structure 15 are defined to assure a proper light path and a better display quality. Hence, the 3D image display apparatus 1 of this embodiment can provide multi-view stereoscopic images, and the pixels P and the first optical units 131 can be adjusted by the tracking module 11 identifying the location of the target (such as the eye position of the user) so that the light can be emitted to the two eyes of the user, and therefore the ineffective energy consumption can be avoided and the display efficiency can be thus enhanced. Besides, when the first optical structure 13 and the second optical structure 15 of this embodiment don't implement the above-mentioned function, the user can view the non-stereoscopic image, and therefore the display apparatus can display stereoscopic or non-stereoscopic images.

FIG. 2B is a schematic diagram of another 3D image display apparatus of the first embodiment of the invention. As shown in FIGS. 2A and 2B, the 3D image display apparatus 1 in FIG. 2A is illustrated to include a first optical unit 131 and two second optical units 151, but however, the favorable case is the 3D image display apparatus T shown in FIG. 2B including a plurality of first optical units 131 and a plurality of second optical units 151 while a first optical unit 131 corresponds to two second optical units 151. Since the illustration of the elements of the 3D image display apparatus T can be comprehended by referring to the above description, the related description is omitted here for conciseness.

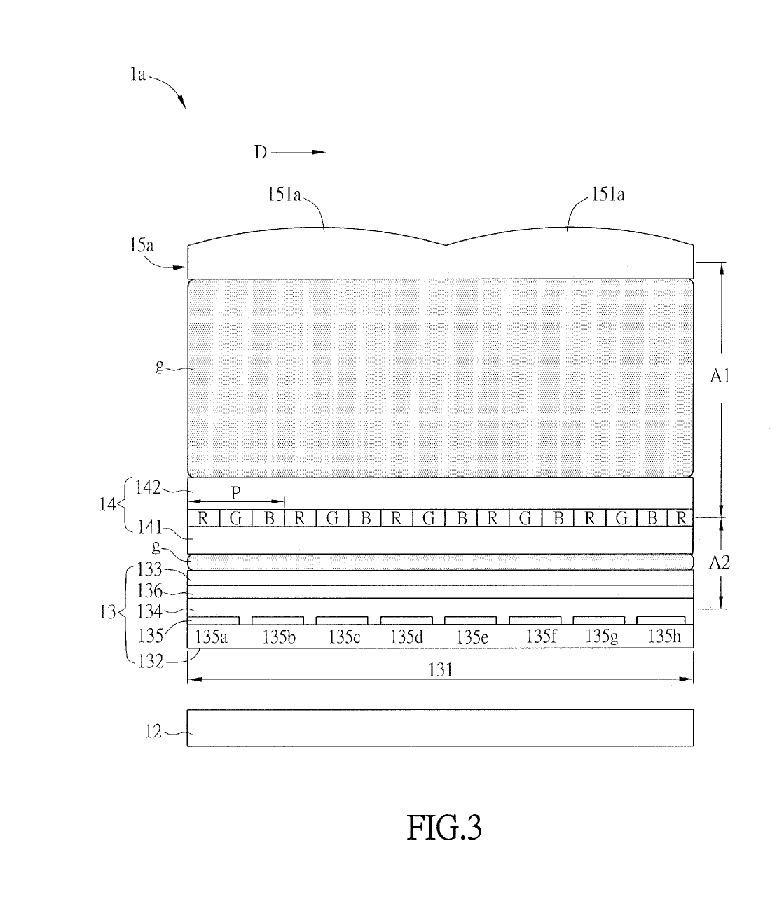

FIG. 3 is a schematic diagram of a 3D image display apparatus 1a of the second embodiment of the invention. As shown in FIG. 3, in this embodiment, the second optical structure 15a is a real lens and especially is a lenticular lens. Likewise, the second optical structure 15a includes a plurality of second optical units 151a, and each of the second optical units 151a includes a lens unit and corresponds to a curvature radius. The projection area of the two adjacent second optical units 151a on the first optical structure 13 covers a first optical unit 131. Moreover, the thickness of the second optical structure 15a of this embodiment is defined as the distance between the upper and lower surfaces of the lens. Likewise, in the 3D image display apparatus 1a of this embodiment, the relation of that the distance A1 from the thickness middle of the second optical structure 15a to the thickness middle of the display panel 14, in the direction perpendicular to the display panel 14, is at least two times the distance A2 from the thickness middle of the display panel 14 to the thickness middle of the first optical structure 13. Besides, the illustration of the tracking module 11, display panel 14 and first optical structure 13 can be comprehended by referring to the description of the first embodiment and is therefore omitted here for conciseness.

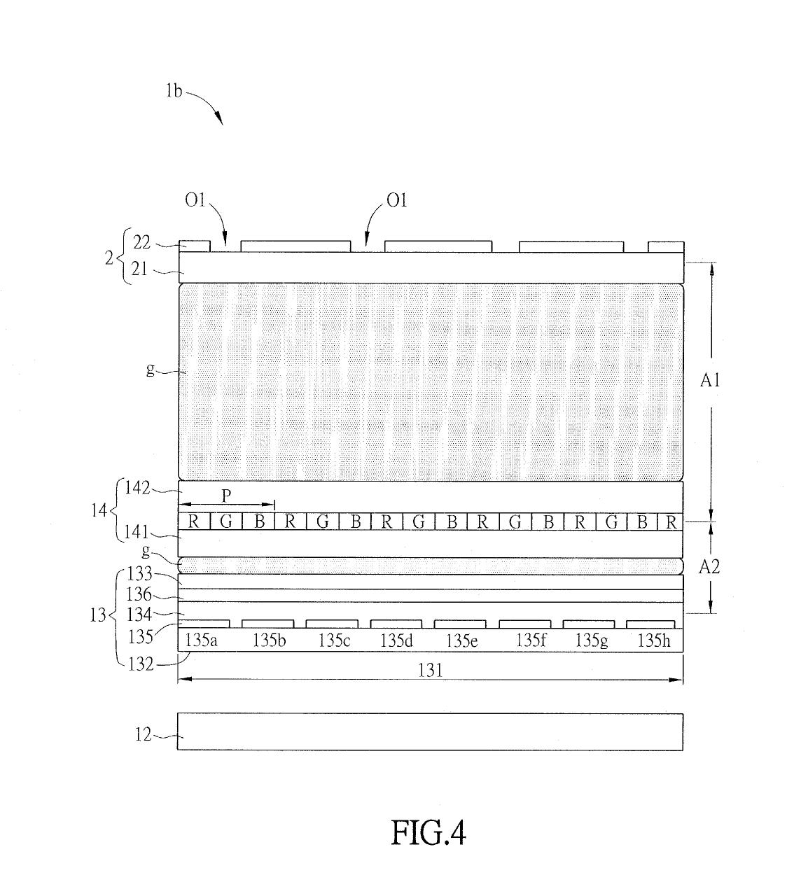

FIG. 4 is a schematic diagram of a 3D image display apparatus 1b of the third embodiment of the invention. As shown in FIG. 4, in this embodiment, the second optical structure 2 is a barrier and includes a plurality of second optical units, and each of the second optical units includes a light pervious region and a light impervious region. The second optical structure 2 can include a first substrate 21 and a blocking layer 22. The blocking layer 22 is disposed on the first substrate 21 and includes a plurality of openings O1. The openings O1 form the light pervious regions and the blocking layer 22 forms the light impervious regions to block the penetration of the light. In this embodiment, the openings O1 are disposed parallelly and separated from each other. Herein, the light can pass through the openings O1 to enter the two eyes of the user so that the multi-view effect can be provided. Besides, the thickness of the second optical structure 2 of this embodiment is defined as the distance between the lower surface (the surface facing the display panel 14) of the first substrate 21 and the upper surface (the surface away from the display panel 14) of the blocking layer 22. Likewise, in the 3D image display apparatus 1b of this embodiment, the relation of that the distance A1 from the thickness middle of the second optical structure 2 to the thickness middle of the display panel 14, in the direction perpendicular to the display panel 14, is at least two times the distance A2 from the thickness middle of the display panel 14 to the thickness middle of the first optical structure 13. Besides, the illustration of the tracking module 11, display panel 14 and first optical structure 13 can be comprehended by referring to the description of the first embodiment and is therefore omitted here for conciseness.

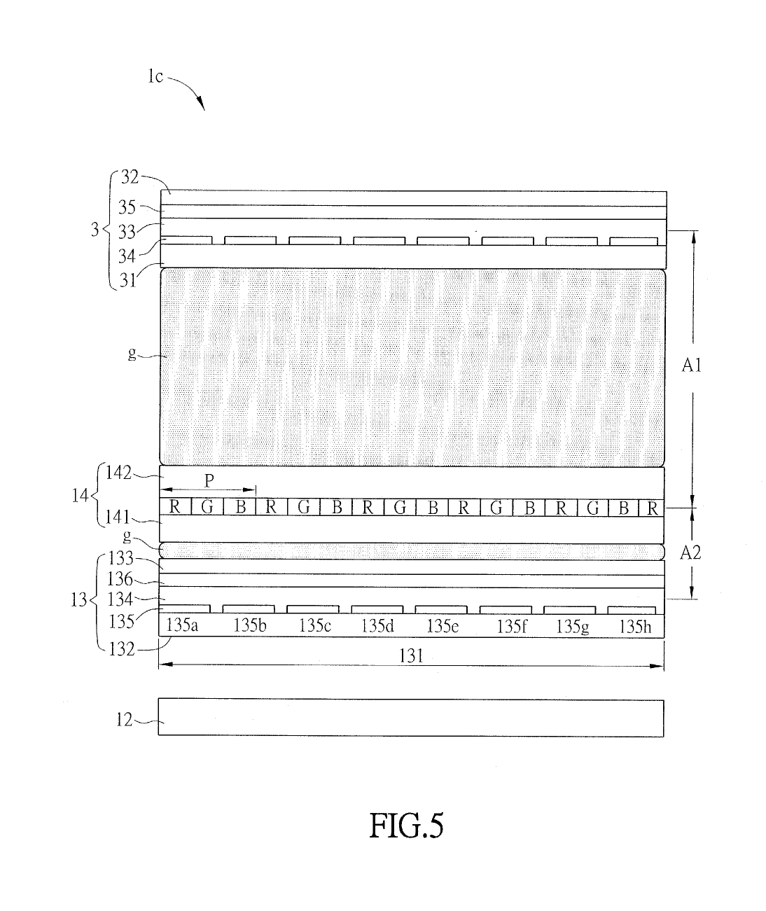

FIG. 5 is a schematic diagram of a 3D image display apparatus 1c of the fourth embodiment of the invention. As shown in FIG. 5, in this embodiment, the second optical structure 3 can be a switchable barrier and includes a plurality of second optical units. The second optical structure 3 includes a first substrate 31, a second substrate 32, a liquid crystal layer 33, a plurality of first electrodes 34 and a plurality of second electrodes 35. The second substrate 32 is disposed opposite the first substrate 31. The liquid crystal layer 33 is disposed between the first substrate 31 and the second substrate 32. The first electrodes 34 are separated from each other and disposed on the first substrate 31. The second electrodes 35 are disposed on the second substrate 32. The liquid crystal layer 33 forms the second light pervious regions and the second light impervious regions according to a plurality of driving voltages applied to the first electrodes 34. The second optical units include the second light pervious regions and the second light impervious regions. For example, the second optical unit can be defined to cover the four consecutive first electrodes 34, and the two consecutive first electrodes 34 are supplied with 5V voltage (high level) and the remaining two first electrodes 34 are not supplied with voltage (low level), while the second electrodes 35 are not supplied with voltage (low level). Meanwhile, the liquid crystal cells of the liquid crystal layer 33 will completely rotate or not rotate according to the applied voltage. Therefore, the liquid crystal layer 33 can show the second light pervious regions which are pervious to light and the second light impervious regions which are impervious to the light, so that the emission angles of the images of the display panel 14 are changed to achieve the multi-view effect. In this embodiment, each of the second light pervious regions or second light impervious regions covers the width of two first electrodes 34. In other embodiments, each of the second light pervious regions or second light impervious regions can cover the width of the first electrodes 34 of another quantity. To be noted, since each of the second optical units covers the four first electrodes 34 and the first optical units are also disposed adjacent to each other, the second light pervious region and/or the second light impervious region can be formed to cover a single second optical unit or the adjacent two second optical units. Moreover, the 5V applied voltage is just for the illustrative purpose and can be changed according to the product design. Besides, the high and low level arrangement of the first electrode 34 and second electrode 35 also can be changed according to the requirement.

In another embodiment, the applied voltage of the first electrodes 34 of the second optical structure 3 can be switched to high or low according to a third switching frequency. The third switching frequency can correspond to a first time segment and a second time segment which are arranged alternately. The third switching frequency can be 140 Hz for example. Physically, the first electrode 34 at the high level during the first time segment will be switched to the low level during the second time segment. Likewise, the first electrode 34 at the low level during the first time segment will be switched to the high level during the second time segment. In other words, by the third switching frequency changing the applied voltage of the first electrode 34, the second light pervious regions and the second light impervious regions formed by the second optical units can be rapidly switched and the position of the second light pervious regions can be thus rapidly switched.

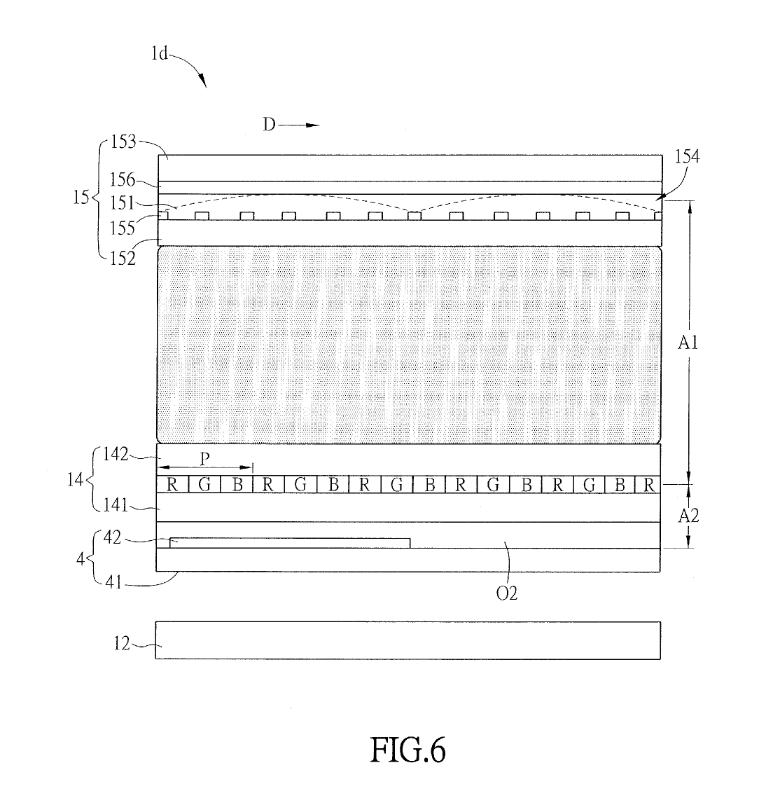

FIG. 6 is a schematic diagram of a 3D image display apparatus 1d of the fifth embodiment of the invention. As shown in FIG. 6, in this embodiment, the first optical structure 4 is a barrier and can include a first substrate 41 and a blocking layer 42. The blocking layer 42 is disposed on the first substrate 41 and includes a plurality of openings O2. The blocking layer 32 can block the penetration of the light. The openings O2 are disposed parallelly and separated from each other. In this embodiment, the projection area of the first optical structure 4 on the second optical structure 15 covers two second optical units 151. Herein, the light can pass through the openings O2 to be divided into the left-eye light beams and the right-eye light beams. Herein, the thickness of the first optical structure 4 of this embodiment is defined as the distance between the upper surface (the surface facing the display panel 14) of the blocking layer 42 and the lower surface (the surface away from the display panel 14) of the first substrate 41. Likewise, in the 3D image display apparatus 1d of this embodiment, the relation of that the distance A1 from the thickness middle of the second optical structure 15 to the thickness middle of the display panel 14, in the direction perpendicular to the display panel 14, is at least two times the distance A2 from the thickness middle of the display panel 14 to the thickness middle of the first optical structure 4. Besides, the illustration of the tracking module 11, display panel 14 and second optical structure 15 can be comprehended by referring to the description of the first embodiment and is therefore omitted here for conciseness.

Summarily, the 3D image display apparatus of this invention can provide stereoscopic images for binocular 3D vision by the disposition of the second optical structure and also accommodation to human eye with high density multiple views for monocular 3D vision by the disposition of the first optical structure at the same time that can solve the accommodation-convergence conflict problem. Besides, the tracking module can output the coordinate information of the target so that the display panel can display images and output the light beams to the user's two eyes according to the coordinate information. Therefore, the ineffective energy consumption can be avoided and the display efficiency can be thus enhanced.

Although the invention has been described with reference to specific embodiments, this description is not meant to be construed in a limiting sense. Various modifications of the disclosed embodiments, as well as alternative embodiments, will be apparent to persons skilled in the art. It is, therefore, contemplated that the appended claims will cover all modifications that fall within the true scope of the invention.

What is claimed is:

1. A three-dimensional (3D) image display apparatus, comprising:
a tracking module outputting a coordinate information of a target;
a backlight module outputting a light;
a first optical structure disposed on the backlight module and splitting the light into at least two light beams;
a display panel disposed on the first optical structure and converting the light beams into a plurality of images according to the coordinate information; and
a second optical structure disposed on the display panel and changing the emission angles of the images of the display panel to achieve the multi-view effect.

2. The three-dimensional image display apparatus as recited in claim 1, wherein the first optical structure includes a plurality of first optical units, each of the first optical units includes a first light pervious region and a first light impervious region, and the first light pervious region and the first light impervious region are disposed adjacent to each other.

3. The three-dimensional image display apparatus as recited in claim 2, wherein the second optical structure includes a plurality of second optical units, the projection area of each of the first optical units on the second optical structure covers two of the second optical units.

4. The three-dimensional image display apparatus as recited in claim 2, wherein the first optical structure comprises:
a first substrate;
a second substrate disposed opposite the first substrate;
a liquid crystal layer disposed between the first substrate and the second substrate;
a plurality of first electrodes disposed on the first substrate and separated from each other; and
a plurality of second electrodes disposed on the second substrate,
wherein the liquid crystal layer forms the first light pervious region and the first light impervious region according to a plurality of driving voltages applied to the first electrodes.

5. The three-dimensional image display apparatus as recited in claim 4, wherein the values of the driving voltages are adjusted according to the coordinate information.

6. The three-dimensional image display apparatus as recited in claim 2, wherein the first optical structure is a barrier.

7. The three-dimensional image display apparatus as recited in claim 3, wherein the second optical structure is a lenticular lens comprising a plurality of lens units, and each of the second optical units includes one of the lens units.

8. The three-dimensional image display apparatus as recited in claim 3, wherein the second optical structure comprises:
a first substrate;
a second substrate disposed opposite the first substrate;
a liquid crystal layer disposed between the first substrate and the second substrate;
a plurality of first electrodes disposed on the first substrate and separated from each other; and
a plurality of second electrodes disposed on the second substrate,
wherein the liquid crystal layer forms a plurality of lens units according to a plurality of driving voltages applied to the first electrodes, and each of the second optical units includes one of the lens units.

9. The three-dimensional image display apparatus as recited in claim 3, wherein the second optical structure comprises:
a first substrate;
a second substrate disposed opposite the first substrate;
a liquid crystal layer disposed between the first substrate and the second substrate;
a plurality of first electrodes disposed on the first substrate and separated from each other; and
a plurality of second electrodes disposed on the second substrate,
wherein the liquid crystal layer forms a second light pervious region and a second light impervious region according to a plurality of driving voltages applied to the first electrodes, each of the second optical units includes the second light pervious region and the second light impervious region, and the second light pervious region and the second light impervious region are disposed adjacent to each other.

10. The three-dimensional image display apparatus as recited in claim 3, wherein the second optical structure is a barrier comprising the second optical units, each of the second optical units includes a light pervious region and a light impervious region, and the light pervious region and the light impervious region are disposed adjacent to each other.

11. The three-dimensional image display apparatus as recited in claim 1, wherein along the direction perpendicular to the display panel, the distance from a thickness middle of the second optical structure to a thickness middle of the display panel is at least twice the distance from a thickness middle of the display panel to a thickness middle of the first optical structure.

12. The three-dimensional image display apparatus as recited in claim 1, wherein the adjacent images have an included angle between 0.2° and 0.4°.
